(19) United States
(12) Patent Application Publication
(10) Pub. No.: US 2017/0294989 A1
(43) Pub. Date: Oct. 12, 2017

(54) METHOD AND DEVICE FOR DATA TRANSMISSION

(71) Applicant: China Academy of Telecommunications Technology, Beijing (CN)

(72) Inventors: Li CHEN, Beijing (CN); Bin JIAO, Beijing (CN); Shaoli KANG, Beijing (CN); Fei QIN, Beijing (CN)

(73) Assignee: China Academy of Telecommunications Technology, Beijing (CN)

(21) Appl. No.: 15/507,702

(22) PCT Filed: Aug. 14, 2015
(86) PCT No.: PCT/CN2015/086993

§ 371 Date: Feb. 28, 2017

(30) Foreign Application Priority Data
Sep. 1, 2014 (CN) 201410441703.8

(51) Int. Cl. H04L 1/18; H04L 29/08

(52) U.S. Cl. CPC H04L 1/18; H04L 67/12; H04B 2203/5441; H04W 4/005

(57) ABSTRACT

Embodiments of the present application relate to the technical field of wireless communications, and particularly to a method and device for data transmission, which are used to solve the problem in the prior art that a retransmission mechanism of an LTE system can meet general requirements for delay and reliability of the LTE but cannot meet higher requirements for delay and reliability caused by the application of new services. The method in the embodiments of the present invention comprises: a receiving side receives data from a sending side through multiple paths, the received data of each path being identical; and the receiving side performs multi-path data combination on the received data. According to the embodiments of the present invention, data is transmitted between a sending side and a receiving side through multiple paths, and data transmitted through each path is identical, so that the purpose of retransmission for many times is achieved, different radio channels can be fully utilized for connection, and the reliability of data transmission can be ensured with low requirements for delay.

This application claims priority to Chinese Patent Application No. 201410441703.8, filed with the Chinese Patent Office on Sep. 1, 2014 and entitled “Method and device for transmitting data”, which is hereby incorporated by reference in its entirety.

### FIELD

The present invention relates to the field of wireless communications, and particularly to a method and device for transmitting data.

### BACKGROUND

With development of the mobile Internet and Internet of Things, there is an explosively growing demand for the amount of service data, and a great number of connected devices, and a great diversity of services over the Internet of Things also pose new technology challenges to mobile communication. The delay in and the reliability of an existing communication system has been designed for human-to-human communication, and a future wireless mobile communication system intended to further satisfy better the demand for communication between human users in terms of its delay and reliability also needs to accommodate real-time and highly reliable Machine Type Communication (MTC) as required so as to promote applications thereof in the industry fields of traffic security, traffic efficiency, intelligent power grids, etc., thus making the concept of our intelligent society and intelligent planet possible in the future. A shorter delay in and high reliability of the future wireless mobile communication system will be required in the new application fields thereof.

In the standard of Quality of Service (QoS) Class Identifier characteristics defined by the 3rd Generation Partnership Project (3GPP), generally there is no strict delay as required.

Even the strictest delays as required are 100 ms for a session application, and 50 ms for a real-time game application.

However as new applications, e.g., remote industry control, augmented reality, etc., are emerging constantly, a shorter delay and high reliability of the wireless communication system has been required.

In the prior art, the reliability of transmission is guaranteed by retransmitting a data packet, and taking a Long Term Evolution (LTE) system as an example, there are physical layer Hybrid Automatic Repeat Request (HARQ), high-layer Automatic Repeat Request (ARQ), higher-layer, e.g., Internet Protocol (IP) layer, retransmission, and other technologies. The HARQ technology which relates to physical layer retransmission is such a technology to guarantee the reliability that has the shortest delay in the LTE system.

At present, the retransmission mechanisms in the LTE system can accommodate the general delay and reliability as required in the LTE specification, but these retransmission mechanisms may fail to accommodate a shorter delay and higher reliability as required in the new service applications.

### SUMMARY

Embodiments of the invention provide a method and device for transmitting data so as to address such a problem in the prior art that the retransmission mechanisms in the LTE system can accommodate the general delay and reliability as required in the LTE specification, but these retransmission mechanisms may fail to accommodate a shorter delay and higher reliability as required in the new service applications.

An embodiment of the invention provides a method for transmitting data, the method including:

receiving, by a receiving side, data from a transmitting side over multiple paths, over each of which the same data are received; and

combining, by the receiving side, the received data over the multiple paths.

Optionally the receiving side is a network side, and the receiving side includes a plurality of first receiving units participating in transmission over the multiple paths; and

receiving, by the receiving side, the data from the transmitting side over the multiple paths includes:

receiving, by each of first receiving units, the data from the transmitting side over respective one of the paths.

Optionally each of the first receiving units is located in a base station or a cell of a wireless communication system.

Optionally combining, by the receiving side, the received data over the multiple paths includes:

transmitting, by each of the first receiving units, the received data to the same first receiving unit participating in transmission over the multiple paths, or the first receiving unit in a primary connection; and

combining, by the first receiving unit receiving the data transmitted by the other first receiving units, the received data from the transmitting side with the received data from the other first receiving units over the multiple paths.

Optionally combining, by the receiving side, the received data over the multiple paths includes:

transmitting, by each of the first receiving units, the receive data to a first data interface unit in the receiving side; and

combining, by the first data interface unit, the received data from the plurality of first receiving units over the multiple paths.

Optionally the method further includes:

for a data packet in the data, receiving, by the one of the first receiving units which is connected with the transmitting side by the primary connection, or the first data interface unit, the data packet, and instructing the transmitting side to stop the data packet from being transmitted, when a part or all of the following conditions are satisfied:

at least one of the first receiving units receives correctly the data packet of the transmitting side, or the first data interface unit determines that the data packet is received correctly, after combining the data over the multiple paths;

a part or all of the first receiving units have received the same data packet from the transmitting side for such a number of times that reaches a largest number of transmissions; and

the data packet transmitted by the transmitting side is received at such a delay that reaches a longest transmission delay.

Optionally the receiving side is the terminal side, and the receiving side includes one second data interface unit and one second receiving unit;

receiving, by the receiving side, the data from the transmitting side over the multiple paths includes:

receiving, by the second data interface unit, the data from the transmitting side over the multiple paths;

combining, by the receiving side, the received data over the multiple paths includes:

combining, by the second data interface unit, the received data over the multiple paths; and

after the receiving side combines the received data over the multiple paths, the method further includes:

transmitting, by the second data interface unit, the combined data over the multiple paths to the second receiving unit.

Optionally the method further includes:

for a data packet in the data, instructing, by the second data interface unit or the second receiving unit, the transmitting side to stop the data packet from being transmitted, when a part or all of the following conditions are satisfied:

the second data interface unit determines that the data packet is received correctly, after combining the data over the multiple paths;

the same data packet from the transmitting side over one of the paths or all the paths has been received for such a number of times that reaches the largest number of transmissions; and

the data packet transmitted from the transmitting side is received at such a delay that reaches the longest transmission delay.

Optionally

the second data interface unit and the second receiving unit are located in a terminal; or

the second data interface unit and the second receiving unit are located in different entities, and the second receiving unit is located in a terminal.

An embodiment of the invention provides a method for transmitting data, the method including:

determining, by a transmitting side, that data need to be transmitted to a receiving side over multiple paths; and

transmitting, by the transmitting side, the data to the receiving side over the multiple paths, over each of which the same data are transmitted.

Optionally the transmitting side is a network side, and the transmitting side includes a plurality of first transmitting units participating in transmission over the multiple paths; and

transmitting, by the transmitting side, the data to the receiving side over the multiple paths includes:

transmitting, by each of the first transmitting units, the same data to the receiving side over respective one of the paths.

Optionally each of the first transmitting units is located in a base station or a cell of a wireless communication system.

Optionally before the transmitting side transmits the data to the receiving side over the multiple paths, the method further includes:

backing up, by a first data processing unit in the transmitting side, the data to be transmitted for the multiple paths, and transmitting a plurality of duplicated data packets obtained as a result of backing up respectively to the respective first transmitting units.

Optionally the transmitting side is a terminal side, and the transmitting side includes one second data processing unit and one second transmitting unit;

before the transmitting side transmits the data to the receiving side over the multiple paths, the method further includes:

transmitting, by the second transmitting unit, the data to be transmitted, to the second data processing unit; and

transmitting, by the transmitting side, the data to the receiving side over the multiple paths includes:

backing up, by the second data processing unit, the received data for the multiple paths, and transmitting a plurality of duplicated data packets obtained as a result of backing up to the receiving side respectively over the multiple paths.

Optionally the second data processing unit and the second transmitting unit are located in a terminal; or

the second data processing unit and the second transmitting unit are located in different entities, and the second transmitting unit is located in the terminal.

Optionally after the transmitting side transmits the data to the receiving side over the multiple paths, the method further includes:

stopping, by the transmitting side, the data from being transmitted over all the paths, upon reception of a feedback from the receiving side that the data are received correctly or stopped from being transmitted.

An embodiment of the invention provides a method for transmitting data, the method including:

determining, by a control unit, that data need to be transmitted over multiple paths between a transmitting side and a receiving side; and

instructing, by the control unit, the transmitting side to transmit the data over the multiple paths, so that the transmitting side transmits the same data to the receiving side over the multiple paths.

Optionally determining, by the control unit, that the data need to be transmitted over the multiple paths between the transmitting side and the receiving side includes:

if the transmitting side is a terminal side, then determining, by the control unit, the data need to be transmitted over multiple paths, according to the performance of the transmitting side, and/or a service to be transmitted; or

if the receiving side is the terminal side, then determining, by the control unit, the data need to be transmitted over multiple paths, according to the performance of the receiving side, and/or a service to be transmitted.

Optionally after the control unit determines that the data need to be transmitted over the multiple paths, the method further includes:

instructing, by the control unit, the receiving side to receive the data over the multiple paths, so that the receiving side receives the same data respectively over the different paths.

Optionally after the control unit determines that the data need to be transmitted over the multiple paths between the transmitting side and the receiving side, and before the control unit instructs the transmitting side to transmit the data over the multiple paths, the method further includes:

selecting, by the control unit, such ones of the paths between the transmitting side and the receiving side that can accommodate a required delay, as paths for transmission between the transmitting side and the receiving side over the multiple paths, and determining the transmitting side and the receiving side corresponding to the transmission paths.

Optionally the control unit is located in the transmitting side or the receiving side, or is a separate unit entity.

An embodiment of the invention provides a first receiving unit for transmitting data, the first receiving unit including:

a first path determining module configured to determine paths to the transmitting side; and

a first receiving module configured to receive data from a transmitting side over the determined paths together with other first receiving units, wherein the same data are received over each of the paths.

Optionally each of the first receiving units is located in a base station or a cell of a wireless communication system.

Optionally the first receiving module is further configured:

to transmit the received data to a first data interface unit, so that the first data interface unit combines the received data from the plurality of first receiving units over the multiple paths.

Optionally the first receiving module is further configured:

for a data packet in the data, to instruct the transmitting side to stop the data packet from being transmitted, when a part or all of the following conditions are satisfied:

at least one of the first receiving units receives correctly the data packet of the transmitting side, or the first data interface unit determines that the data packet is received correctly, after combining the data over the multiple paths;

a part or all of the first receiving units have received the same data packet from the transmitting side for such a number of times that reaches the largest number of transmissions; and

the data packet transmitted from the transmitting side is received at such a delay that reaches the longest transmission delay.

An embodiment of the invention provides a first data interface unit for transmitting data, the first data interface unit including:

a second receiving module configured to receive data from a plurality of first receiving units, wherein the data of each first receiving unit are data received from the transmitting side over a different one of paths, and the same data are transmitted over each of the paths; and

a first combining module configured to combine the received data from the plurality of first receiving units over the multiple paths.

Optionally each of the first receiving units is located in a base station or a cell of a wireless communication system.

Optionally the first data interface unit and the first receiving unit are located in the same entity or different entities.

An embodiment of the invention provides a second receiving unit for transmitting data, the second receiving unit including:

a second path determining module configured to determine paths to a second data interface unit; and

a third receiving module configured to receive first specific data from the second data interface unit over the determined paths, wherein the first specific data are obtained by the second data interface unit combining data received over multiple paths, over each of which the same data are transmitted.

Optionally the third receiving module is further configured:

for a data packet in the data, to instruct the transmitting side to stop the data packet from being transmitted, when a part or all of the following conditions are satisfied:

the second data interface unit determines that the data packet is received correctly, after combining the data over the multiple paths;

the same data packet from the transmitting side over one of the paths or all the paths has been received for such a number of times that reaches the largest number of transmissions; and

the data packet transmitted from the transmitting side is received at such a delay that reaches the longest transmission delay.

Optionally the second data interface unit and the second receiving unit are located in a terminal; or

the second data interface unit and the second receiving unit are located in different entities, and the second receiving unit is located in a terminal.

An embodiment of the invention provides a second data interface unit for transmitting data, the second data interface unit including:

a third path determining module configured to determine multiple paths to the transmitting side; and

a fourth receiving module configured to receive data from the transmitting side over the determined multiple paths, to combine the received data over the multiple paths, and to transmit the combined data to a second receiving unit, wherein the same data are received over the respective paths.

Optionally the fourth receiving module is further configured:

for a data packet in the data, to instruct the transmitting side to stop the data packet from being transmitted, when a part or all of the following conditions are satisfied:

the second data interface unit determines that the data packet is received correctly, after combining the data over the multiple paths;

the same data packet from the transmitting side over one of the paths or all the paths has been received for such a number of times that reaches the largest number of transmissions; and

the data packet transmitted from the transmitting side is received at such a delay that reaches the longest transmission delay.

Optionally the second data interface unit and the second receiving unit are located in a terminal; or

the second data interface unit and the second receiving unit are located in different entities, and the second receiving unit is located in a terminal.

An embodiment of the invention provides a first transmitting unit for transmitting data, the first transmitting unit including:

a fourth path determining module configured to determine paths to the receiving side; and

a first transmitting module configured to transmit data to the receiving side over the determined paths together with other first transmitting modules, wherein the same data are transmitted over each of the paths.

Optionally each of the first transmitting units is located in a base station or a cell of a wireless communication system.

Optionally the first transmitting module is further configured:

to receive second specific data from a first data processing unit, and to determine the second specific data as data to be transmitted, wherein the second specific data are obtained by the first data processing unit backing up the data to be transmitted, for the multiple paths.

An embodiment of the invention provides a first data processing unit for transmitting data, the first data processing including:

a first processing module configured to back up data to be transmitted, for multiple paths; and

a second transmitting module configured to transmit the processed data respectively to each of first transmitting units, so that each of the first transmitting units transmits the same data to the receiving side respectively over a different one of paths.

Optionally each of the first transmitting units is located in a base station or a cell of a wireless communication system.

Optionally the first data processing unit and the first transmitting unit are located in the same entity or different entities.

An embodiment of the invention provides a second transmitting unit for transmitting data, the second transmitting unit including:

a fifth path determining module configured to determine paths to a second data processing unit; and

a third transmitting module configured to transmit data to the second data processing unit over the determined paths, so that the second data processing unit backs up the received data for multiple paths, and transmits a plurality of duplicated data packets obtained as a result of backing up to the receiving side respectively over the multiple paths.

Optionally the second data processing unit and the second transmitting unit are located in a terminal; or

the second data processing unit and the second transmitting unit are located in different entities, and the second transmitting unit is located in a terminal.

An embodiment of the invention provides a second data processing unit for transmitting data, the second data processing unit including:

a second processing module configured to back up received data for multiple paths from a second transmitting unit; and

a fourth transmitting module configured to transmit a plurality of duplicated data packets obtained as a result of backing up to the receiving side respectively over the multiple paths.

Optionally the second data processing unit and the second transmitting unit are located in a terminal; or

the second data processing unit and the second transmitting unit are located in different entities, and the second transmitting unit is located in a terminal.

An embodiment of the invention provides a base station including a processor, a transceiver, and a memory, wherein:

the transceiver is configured to be controlled by the processor to transmit and receive data; and

the memory is configured to store data for use by the processor in operation;

if the base station is a receiver, then the processor is configured to read programs in the memory, and perform the processes of:

determining paths to the transmitting side; and

receiving data from the transmitting side through the transceiver over the determined paths together with other base stations, wherein the same data are received over each of the paths.

Optionally the base station further includes a communication interface configured to be controlled by the processor to transmit data to other entities at the network side, and to be controlled by the processor to receive data transmitted by the other entities at the network side; and correspondingly the processor is further configured to read the data in the memory, and to perform the process of:

transmitting the received data to a first data interface unit via the communication interface, so that the first data interface unit combines the received data from the plurality of first receiving units over the multiple paths.

Optionally the processor is further configured to read the data in the memory, and to perform the process of:

for a data packet in the data, instructing the transmitting side through the transceiver to stop the data packet from being transmitted, when a part or all of the following conditions are satisfied:

at least one of the base stations receives correctly the data packet of the transmitting side, or the first data interface unit determines that the data packet is received correctly, after combining the data over the multiple paths;

a part or all of the base stations have received the same data packet from the transmitting side for such a number of times that reaches a largest number of transmissions; and

the data packet transmitted from the transmitting side is received at such a delay that reaches a longest transmission delay.

If the base station is a transmitter, then the processor is configured to read data in the memory, and perform the processes of:

determine paths to the receiving side; and

transmitting data to the receiving side through the transceiver over the determined paths together with other base stations, wherein the same data are transmitted over each of the paths.

Optionally the base station further includes a communication interface configured to be controlled by the processor to transmit data to other entities at the network side, and to be controlled by the processor to receive data transmitted by the other entities at the network side; and correspondingly the processor is further configured to read the data in the memory, and to perform the processes of:

receiving second specific data from a first data processing unit via the communication interface, and determining the second specific data as data to be transmitted, wherein the second specific data are obtained by the first data processing unit backing up the data to be transmitted, for the multiple paths.

An embodiment of the invention provides a first data interface unit for transmitting data, the first data interface unit including a processor, a communication interface, and a memory, wherein:

the processor is configured to read programs in the memory, and to perform the processes of:

receiving data from a plurality of base stations via the communication interface, wherein the data of each base station are data received from the transmitting side over a different one of paths, and the same data are transmitted over each of the paths; and combining the received data from the plurality of base stations over the multiple paths;

the communication interface is configured to be controlled by the processor to transmit data to other entities at the network side, and to be controlled by the processor to receive data transmitted by the other entities at the network side; and the memory is configured to store data for use by the processor in operation.

An embodiment of the invention provides a first data processing unit for transmitting data, the first data processing unit including a processor, a communication interface, and a memory, wherein:

the processor is configured to read programs in the memory, and to perform the processes of:

backing up data to be transmitted, for multiple paths; and

transmitting the processed data respectively to each of base stations via the communication interface, so that each of the base stations transmits the same data to the receiving side respectively over a different one of the paths;

the communication interface is configured to be controlled by the processor to transmit data to other entities at the network side, and to be controlled by the processor to receive data transmitted by the other entities at the network side; and the memory is configured to store data for use by the processor in operation.

An embodiment of the invention provides a terminal including a processor, a memory, and a transceiver, wherein:

the memory is configured to store data for use by the processor in operation;

the transceiver is configured to be controlled by the processor to transmit and receive data.

If the terminal is a receiver, then the processor is configured to read the data in the memory, and to perform the processes of:

receiving data from the transmitting side over multiple paths, over each of which the same data are transmitted; and

combining the received data over the multiple paths.

Optionally the processor is further configured to read the programs in the memory, and to perform the process of:

for a data packet in the data, instructing the transmitting side to stop the data packet from being transmitted, when a part or all of the following conditions are satisfied:

it is determined that the data packet is received correctly, after combining the data over the multiple paths;

the same data packet from the transmitting side over one of the paths or all the paths has been received for such a number of times that reaches the largest number of transmissions; and

the data packet transmitted from the transmitting side is received at such a delay that reaches the longest transmission delay.

Optionally the terminal further includes a communication interface configured to be controlled by the processor to transmit data to other entities at the network side, and to be controlled by the processor to receive data transmitted by the other entities at the network side; and correspondingly the processor is configured to read programs in the memory, and to perform the processes of:

determining paths to a second data interface unit; and

receiving first specific data from the second data interface unit over the determined paths via the communication interface, wherein the first specific data are obtained by the second data interface unit combining data received over multiple paths, over each of which the same data are transmitted.

If the terminal is a transmitter, then the processor will be configured to read programs in the memory, and to perform the processes of:

determining that data need to be transmitted to the receiving side over multiple paths; and

transmitting the data to the receiving side through the transceiver over the multiple paths, over each of which the same data are transmitted.

Optionally the terminal further includes a communication interface configured to be controlled by the processor to transmit data to a second data processing unit, and to be controlled by the processor to receive data transmitted by the second data processing unit; and correspondingly the processor is configured to read programs in the memory, and to perform the processes of:

determining paths to the second data processing unit; and

transmitting data to the second data processing unit over the determined paths, so that the second data processing unit backs up the received data for multiple paths, and transmits a plurality of duplicated data packets obtained as a result of backing up to the receiving side respectively over the multiple paths.

An embodiment of the invention provides a second data interface unit for transmitting data, the second data interface unit including a processor, a memory, and a communication interface, wherein:

the processor is configured to read programs in the memory, and to perform the processes of:

determining paths to the transmitting side; and

receiving data from the transmitting side over the determined multiple paths, combining the received data over the multiple paths, and transmitting the combined data to a terminal via the communication interface, wherein the same data are received over each of the paths;

the memory is configured to store data for use by the processor in operation; and

the communication interface is configured to be controlled by the processor to receive data of the terminal, and to be controlled by the processor to transmit data to the terminal.

Optionally the processor is further configured to read the programs in the memory, and to perform the process of:

for a data packet in the data, instructing the transmitting side to stop the data packet from being transmitted, when a part or all of the following conditions are satisfied:

the second data interface unit determines that the data packet is received correctly, after combining the data over the multiple paths;

the same data packet from the transmitting side over one of the paths or all the paths has been received for such a number of times that reaches the largest number of transmissions; and

the data packet transmitted from the transmitting side is received at such a delay that reaches the longest transmission delay.

An embodiment of the invention provides a second data processing unit for transmitting data, the second data processing unit including a processor, a memory, and a communication interface, wherein:

the processor is configured to read programs in the memory, and to perform the processes of:

backing up data received via the communication interface from a terminal for multiple paths; and

transmitting a plurality of duplicated data packets obtained as a result of backing up to the receiving side respectively over the multiple paths.

An embodiment of the invention provides a control unit for transmitting data, the control unit including:

a transmission mode determining module configured to determine that data need to be transmitted between a transmitting side and a receiving side over multiple paths; and

an instructing module configured to instruct the transmitting side to transmit over the multiple paths, so that the transmitting side transmits the same data to the receiving side over the multiple paths.

Optionally the transmission mode determining module is configured:

if the transmitting side is the terminal side, to determine that the data need to be transmitted over the multiple paths, according to the performance of the transmitting side, and/or a service to be transmitted; or if the receiving side is the terminal side, to determine that the data need to be transmitted over the multiple paths, according to the performance of the receiving side, and/or a service to be transmitted.

Optionally the instructing module is further configured:

to instruct the receiving side to receive over the multiple paths, so that the receiving side receives the same data respectively over the different paths.

Optionally the transmission mode determining module is further configured:

to select such ones of the paths between the transmitting side and the receiving side that can accommodate a required delay, as the paths for transmission between the transmitting side and the receiving side over the multiple paths, and to determine the transmitting side and the receiving side corresponding to the transmission paths.

Optionally the control unit is located in the transmitting side or the receiving side, or is a separate unit entity.

An embodiment of the invention provides a control unit for transmitting data, the control unit including:

a processor configured to read programs in a memory, and to perform the processes of:

determining that data need to be transmitted between the transmitting side and the receiving side over multiple paths; and

instructing the transmitting side to transmit over the multiple paths via a communication interface, so that the transmitting side transmits the same data to the receiving side over the multiple paths;

the memory configured to store data for use by the processor in operation; and

the communication interface configured to be controlled by the processor to exchange data with the transmitting side and the receiving side.

Optionally the processor is configured to read the programs in the memory, and to perform the processes of:

if the transmitting side is the terminal side, to determine that the data need to be transmitted over the multiple paths, according to the performance of the transmitting side, and/or a service to be transmitted; or if the receiving side is the terminal side, to determine that the data need to be transmitted over the multiple paths, according to the performance of the receiving side, and/or a service to be transmitted.

Optionally the processor is further configured to read the programs in the memory, and to perform the process of:

to instruct the receiving side to receive over the multiple paths, so that the receiving side receives the same data respectively over the different paths.

Optionally the processor is further configured to read the programs in the memory, and to perform the process of:

to select such ones of the paths between the transmitting side and the receiving side that can accommodate a required delay, as the paths for transmission between the transmitting side and the receiving side over the multiple paths, and to determine the transmitting side and the receiving side corresponding to the transmission paths.

In the embodiments of the invention, the data are transmitted between the transmitting side and the receiving side over the multiple paths, over each of which the same data are transmitted, for the purpose of transmitting the data repeatedly for a number of times to thereby make full use of the different wireless channel connections, and guarantee the reliability in transmitting the data at the short delay as required.

### BRIEF DESCRIPTION OF THE DRAWINGS

FIG. 1 is a schematic flow chart of a method for transmitting data in accordance with a first embodiment of the invention;

FIG. 2 is a schematic flow chart of a method for transmitting data in accordance with a second embodiment of the invention;

FIG. 3 is a schematic flow chart of a method for transmitting data in accordance with a third embodiment of the invention;

FIG. 4 is a schematic structural diagram of a first receiving unit in accordance with a fourth embodiment of the invention;

FIG. 5 is a schematic structural diagram of a first data interface unit in accordance with a fifth embodiment of the invention;

FIG. 6 is a schematic structural diagram of a second receiving unit in accordance with a sixth embodiment of the invention;

FIG. 7 is a schematic structural diagram of a second interface unit in accordance with a seventh embodiment of the invention;

FIG. 8 is a schematic structural diagram of a first transmitting unit in accordance with an eighth embodiment of the invention;

FIG. 9 is a schematic structural diagram of a first data processing unit in accordance with a ninth embodiment of the invention;

FIG. 10 is a schematic structural diagram of a second transmitting unit in accordance with a tenth embodiment of the invention;

FIG. 11 is a schematic structural diagram of a second data processing unit in accordance with an eleventh embodiment of the invention;

FIG. 12 is a schematic structural diagram of a control unit in accordance with a twelfth embodiment of the invention;

FIG. 13 is a schematic structural diagram of a system for transmitting in the downlink in accordance with a thirteenth embodiment of the invention;

FIG. 14 is a schematic structural diagram of a system for transmitting in the uplink in accordance with a fourth embodiment of the invention;

FIG. 15 is a schematic diagram of a control unit controlling a plurality of wireless communication system centrally in accordance with a fifteenth embodiment of the invention;

FIG. 16 is a schematic diagram of a control unit controlling a plurality of cells in a wireless communication system centrally in accordance with a sixteenth embodiment of the invention;

FIG. 17 is a schematic diagram of starting transmission over multiple paths as a result of negotiation in accordance with a seventeen embodiment of the invention;

FIG. 18 is a schematic diagram of a terminal controlling transmission over multiple paths in accordance with an eighteenth embodiment of the invention;

FIG. 19 is a schematic diagram of a terminal transmitting with blind redundancy in accordance with a ninth embodiment of the invention;

FIG. 20 is a schematic structural diagram of a base station in accordance with a twentieth embodiment of the invention;

FIG. 21 is a schematic diagram of a first data interface unit in accordance with a twenty-first embodiment of the invention;

FIG. 22 is a schematic diagram of a first data processing unit in accordance with a twenty-second embodiment of the invention;

FIG. 23 is a schematic structural diagram of a terminal in accordance with a twenty-third embodiment of the invention;

FIG. 24 is a schematic diagram of a second data interface unit in accordance with a twenty-fourth embodiment of the invention;

FIG. 25 is a schematic diagram of a second data processing unit in accordance with a twenty-fifth embodiment of the invention; and

FIG. 26 is a schematic diagram of a control unit in accordance with a twenty-sixth embodiment of the invention.

### DETAILED DESCRIPTION

In the embodiments of the invention, data are transmitted over multiple paths between the transmitting side and the receiving side, over each of which the same data are transmitted, for the purpose of transmitting the data repeatedly for a number of times to thereby make full use of the different wireless channel connections, and guarantee the reliability in transmitting the data at the short delay as required.

The embodiments of the invention will be described below in further details with reference to the drawings.

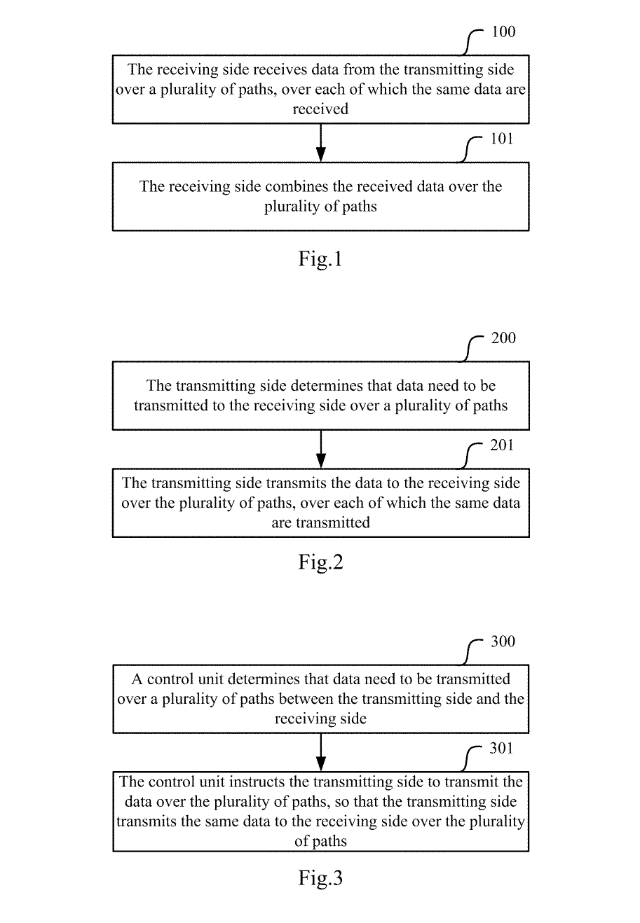

As illustrated in FIG. 1, a method for transmitting data according to a first embodiment of the invention includes the following steps:

In the step 100, the receiving side receives data from the transmitting side over multiple paths, over each of which the same data are received; and

In the step 101, the receiving side combines the received data over the multiple paths.

If the data are transmitted in the uplink, then the transmitting side is the terminal side, and the receiving side is the network side; and

If the data are transmitted in the downlink, then the transmitting side is the network side, and the receiving side is the terminal side.

These two instances will be introduced below respectively.

The first instance relates to uplink transmission where the transmitting side is the terminal side, and the receiving side is the network side.

Particularly the receiving side includes a plurality of first receiving units participating in transmission over the multiple paths; and

The receiving side receives the data from the transmitting side over the multiple paths as follows:

Each first receiving unit receives the data from the transmitting side over respective one of the paths.

In the embodiment of the invention, each first receiving unit is connected with the transmitting side, and each first receiving unit receives the same data transmitted by the transmitting side over respective one of the paths for the purpose of transmitting the data repeatedly for a number of times to thereby make full use of the different wireless channel connections, and guarantee the reliability in transmitting the data at the short delay as required.

In an implementation, each of the first receiving units can be located in a base station or a cell of a wireless communication system.

If each of the first receiving units is located in a base station of a wireless communication system, then each first receiving unit is located in respective one of base stations, and the base stations including the first receiving units are located in the same wireless communication system; or the base stations are located in different wireless communication systems; or a part of the base stations are located in the same wireless communication system.

After each of the first receiving units receives the same data, the data over the multiple paths can be further combined. In an embodiment of the invention, a function of combining the data over the multiple paths can be centralized in some first receiving unit, or the function of combining the data over the multiple paths can be arranged in a new unit, as introduced below in details.

First scheme: the function of combining the data over the multiple paths is centralized in some first receiving unit.

Particularly each of the first receiving units transmits the received data to the same first receiving unit participating in transmission over the multiple paths, or the first receiving unit in a primary connection; and

The first receiving unit receiving the data transmitted by the other first receiving units combines the received data from the transmitting side with the received data from the other first receiving units over the multiple paths.

The primary connection (referred to a primary link) refers to a primary connection over which a user equipment communicates with the network side, where typically underlying control signaling is transmitted over the primary connection to keep the terminal connected, and control information related to transmission over the multiple paths may only be transmitted over the primary connection.

In an implementation, particularly the first receiving unit to combine the data over the multiple paths can be any one of the first receiving units, and each first receiving unit can negotiate about and determine to which first receiving unit the received data are currently transmitted. For example, lightly loaded one of the first receiving units can be selected as the first receiving unit to combine the data over the multiple paths, according to current loads of the first receiving units.

Optionally since each first receiving unit is connected with the transmitting side, in an implementation, one of the connections can be selected as the primary connection, where the first receiving unit corresponding to the connection is the first receiving unit in the primary connection, and each first receiving unit receiving the data can transmit the data to the first receiving unit in the primary connection, so that the first receiving unit in the primary connection combines the data over the multiple paths.

For different data, the data over the multiple paths can be combined by different schemes. Since not all the first receiving units can receive the complete data, whatever data over the multiple paths are combined for the purpose of obtaining the complete data in the embodiment of the invention. Stated otherwise, any scheme to obtain the complete data by combining the data over the multiple paths can be applicable to the embodiment of the invention.

For example, one common scheme is to detect the received data for duplication.

Particularly there are different duplication detection schemes at different transport layers. Generally if there are a plurality of duplicated data packets, then only one of them can be maintained while discarding the other duplicated data packets.

Optionally after the data are detected for duplication, the data packets can be further sorted by the identifiers of the data packets for convenient submission to a higher layer.

In the first scheme, there is further provided a feedback upon reception of a plurality of pieces of data in an embodiment of the invention.

Particularly for a data packet in the data, the one of the first receiving units which is connected with the transmitting side over the primary connection receives the data packet, and instructs the transmitting side to stop the data packet from being transmitted, when a part or all of the following conditions are satisfied:

At least one of the first receiving units receives correctly the data packet of the transmitting side, or the first receiving unit receiving the data transmitted by the other first receiving units determines that the data packet is received correctly, after combining the data over the multiple paths;

A part or all of the first receiving units have received the same data packet of the transmitting side for such a number of times that reaches the largest number of transmissions; and

The data packet transmitted by the transmitting side is received at such a delay that reaches the longest transmission delay.

Second scheme: the function of combining the data over the multiple paths is arranged in a new unit.

Particularly each first receiving unit transmits the received data to a first data interface unit in the receiving side; and

The first data interface unit combines the received data from the plurality of first receiving units over the multiple paths.

For different data, the data over the multiple paths can be combined by different schemes. Since not all the first receiving units can receive the complete data, whatever data over the multiple paths are combined for the purpose of obtaining the complete data in the embodiment of the invention. Stated otherwise, any scheme to obtain the complete data by combining the data over the multiple paths can be applicable to the embodiment of the invention.

For example, one common scheme is to detect the received data for duplication.

Particularly there are different duplication detection schemes at different transport layers. Generally if there are a plurality of duplicated data packets, then only one of them can be maintained while discarding the other duplicated data packets.

Optionally after the data are detected for duplication, the data packets can be further sorted by the identifiers of the data packets for convenient submission to a higher layer.

In an implementation, the first data interface unit and the first receiving unit can be located in the same entity, or can be located in different entities.

If the first data interface unit and the first receiving unit can be located in different entities, then the first data interface unit in the embodiment of the invention has a powerful capability to process data rapidly, and is connected with the first receiving unit rapidly and reliably (e.g., in a wired mode over a short distance), where one first data interface unit can be connected with a plurality of first receiving units.

In the second scheme, there is further provided a feedback upon reception of a plurality of pieces of data in an embodiment of the invention.

Particularly for a data packet in the data, the one of the first receiving units which is connected with the transmitting side over the primary connection, or the first data interface unit receives the data packet, and instructs the transmitting side to stop the data packet from being transmitted, when a part or all of the following conditions are satisfied:

At least one of the first receiving units receives correctly the data packet of the transmitting side, or the first data interface unit determines that the data packet is received correctly, after combining the data over the multiple paths;

A part or all of the first receiving units have received the same data packet of the transmitting side for such a number of times that reaches the largest number of transmissions; and

The data packet transmitted by the transmitting side is received at such a delay that reaches the longest transmission delay.

The second instance relates to downlink transmission where the transmitting side is the network side, and the receiving side is the terminal side.

Particularly the receiving side includes one second data interface unit and one second receiving unit; and

The receiving side receives the data from the transmitting side over the multiple paths as follows:

The second data interface unit receives the data from the transmitting side over the multiple paths;

The receiving side combines the received data over the multiple paths as follows:

The second data interface unit combines the received data over the multiple paths; and

After the receiving side combines the received data over the multiple paths, the method further includes:

The second data interface unit transmits the combined data over the multiple paths to the second receiving unit.

For downlink transmission, there are typically one second data interface unit and one second receiving unit in an implementation.

Typically the second data interface unit receives a plurality of pieces of the same data over the multiple paths, and then combines these data over the multiple paths.

For different data, the data over the multiple paths can be combined by different schemes. Since the second data interface unit may not receive the complete data over each path, whatever data over the multiple paths are combined for the purpose of obtaining the complete data in the embodiment of the invention. Stated otherwise, any scheme to obtain the complete data by combining the data over the multiple paths can be applicable to the embodiment of the invention.

For example, one common scheme is to detect the received data for duplication.

Particularly there are different duplication detection schemes at different transport layers. Generally if there are a plurality of duplicated data packets, then only one of them can be maintained while discarding the other duplicated data packets.

Optionally after the data are detected for duplication, the data packets can be further sorted by the identifiers of the data packets for convenient submission to a higher layer.

In an implementation, the second data interface unit and the second receiving unit are located in a terminal, and the terminal is capable of receiving and combining the data by itself.

However for a less capable terminal, the second data interface unit can alternatively be arranged separately in an entity in an embodiment of the invention, so that a plurality of terminals can be connected with the second data interface unit, so that the second data interface unit combines the data over the multiple paths, and then transmits the processed data to the corresponding terminal. Stated otherwise, the second data interface unit and the second receiving unit are located in different entities, and the second receiving unit is located in the terminal.

If the second data interface unit and the second receiving unit are located in different entities, and the second receiving unit is located in a terminal, then the second data interface unit in the embodiment of the invention will have a powerful capability to process data rapidly, and be connected with the terminal rapidly and reliably (e.g., in a wired mode over a short distance), where one second data interface unit can be connected with a plurality of terminals.

There is further provided a feedback upon reception of a plurality of pieces of data in an embodiment of the invention.

Particularly for a data packet in the data, the second data interface unit or the second receiving unit instructs the transmitting side to stop the data packet from being transmitted, when a part or all of the following conditions are satisfied:

The second data interface unit determines that the data packet is received correctly, after combining the data over the multiple paths;

The same data packet from the transmitting side over one of the paths or all the paths has been received for such a number of times that reaches the largest number of transmissions; and

The data packet from the transmitting side is received at such a delay that reaches the longest transmission delay.

As illustrated in FIG. 2, a method for transmitting data according to a second embodiment of the invention includes the following steps:

In the step 200, the transmitting side determines that data need to be transmitted to the receiving side over multiple paths; and

In the step 201, the transmitting side transmits the data to the receiving side over the multiple paths, over each of which the same data are transmitted.

If the data are transmitted in the downlink, then the transmitting side is the network side, and the receiving side is the terminal side; and

If the data are transmitted in the uplink, then the transmitting side is the terminal side, and the receiving side is the network side.

These two instances will be introduced below respectively.

The first instance relates to downlink transmission where the transmitting side is the network side, and the receiving side is the terminal side.

Particularly the transmitting side includes a plurality of first transmitting units participating in transmission over the multiple paths; and

The transmitting side transmits the data to the receiving side over the multiple paths as follows:

Each first transmitting unit transmits the same data to the receiving side over respective one of the paths.

In the embodiment of the invention, each first transmitting unit is connected with the receiving side, and each first transmitting unit transmits the same data to the receiving side over respective one of the paths for the purpose of transmitting the data repeatedly for a number of times to thereby make full use of the different wireless channel connections, and guarantee the reliability in transmitting the data at the short delay as required.

In an implementation, each of the first transmitting units can be located in a base station or a cell of a wireless communication system.

If each of the first transmitting units is located in a base station of a wireless communication system, then each first transmitting unit can be located in respective one of base stations, and the base stations including the first transmitting units can be located in the same wireless communication system; or the base stations can be located in different wireless communication systems; or a part of the base stations can be located in the same wireless communication system.

Each of the first transmitting units backs up the data for the multiple paths before transmitting the same data. In an embodiment of the invention, a function of backing up the data for the multiple paths can be centralized in a first data processing unit.

Particularly the first data processing unit in the transmitting side backs up the data to be transmitted for the multiple paths, and transmits a plurality of duplicated data packets obtained as a result of backing up respectively to the respective first transmitting units.

The data can be backed up by backing-up, encoding jointly, etc., the data. For example, the first data processing unit duplicates the data to be transmitted into a plurality of copies, each of which is transmitted over one of the transmission paths; or the first data processing unit network-encodes the data to be transmitted into copies, each of which is transmitted over respective one of the paths, and the receiving side combines and encodes the data transmitted over the multiple paths thus further improving the reliability in transmitting the data.

In an implementation, the first data processing unit and the first transmitting units can be located in the same entity, or can be located in different entities.

If they are located in the same entity, then a plurality of first data processing units can be arranged, where only one of the first data processing units processes the data, and then transmits the processed data respectively to the first transmitting units in the other entities.

If they are located in different entities, then only one first data processing unit can be arranged, where the first data processing unit processes the data, and then transmits the processed data respectively to the first transmitting units in the other entities.

If the first data processing unit and the first transmitting units are located in different entities, then the first data processing unit in the embodiment of the invention will have a powerful capability to process data rapidly, and be connected with the first transmitting unit rapidly and reliably (e.g., in a wired mode over a short distance), where one first data processing unit can be connected with a plurality of first transmitting units.

Optionally the transmitting side stops the data from being transmitted over all the paths, upon reception of a feedback from the receiving side that the data are received correctly or stopped from being transmitted.

For example, the first data processing unit instructs the other first data processing units to stop the data from being processed, and the data from being transmitted over their transmission paths, upon reception of the feedback from the receiving side that the data are received correctly or stopped from being transmitted.

The second instance relates to uplink transmission where the transmitting side is the terminal side, and the receiving side is the network side.

Particularly the transmitting side includes one second data processing unit and one second transmitting unit;

Before the transmitting side transmits the data to the receiving side over the multiple paths, the method further includes:

The second transmitting unit transmits the data to be transmitted, to the second data processing unit; and

The transmitting side transmits the data to the receiving side over the multiple paths as follows:

The second data processing unit backs up the received data for the multiple paths, and transmits a plurality of duplicated data packets obtained as a result of backing up to the receiving side respectively over the multiple paths.

The data can be backed up by backing-up, encoding jointly, etc., the data. For example, the second data processing unit duplicates the data to be transmitted into a plurality of copies, each of which is transmitted over one of the transmission paths; or the second data processing unit network-encodes the data to be transmitted into copies, each of which is transmitted over respective one of the paths, and the receiving side combines and encodes the data transmitted over the multiple paths thus further improving the reliability in transmitting the data.

In an implementation, the second data processing unit and the second transmitting unit are located in a terminal capable of backing up and transmitting the data over the multiple paths by itself.

However for a less capable terminal, the second data processing unit can alternatively be arranged separately in an entity in an embodiment of the invention, so that a plurality of terminals can be connected with the second data interface unit, and transmit the data to be transmitted, to the second data processing unit. For a terminal, the second data interface unit backs up the data transmitted by the terminal for the multiple paths, and transmits the processed data to the receiving side over the multiple paths. Stated otherwise, the second data processing unit and the second transmitting unit are located in different entities, and the second transmitting unit is located in the terminal.

If the second data processing unit and the second transmitting unit are located in different entities, and the second transmitting unit is located in a terminal, then the second data processing unit in the embodiment of the invention has a powerful capability to process data rapidly, and be connected with the terminal rapidly and reliably (e.g., in a wired mode over a short distance), where one second data transmitting unit can be connected with a plurality of terminals.

Optionally the transmitting side stops the data from being transmitted over all the paths, upon reception of a feedback from the receiving side that the data are received correctly or stopped from being transmitted.

For example, the second data processing unit stops the data from being transmitted over their transmission paths, upon reception of the feedback from the receiving side that the data are received correctly or stopped from being transmitted.

As illustrated in FIG. 3, a method for transmitting data according to a third embodiment of the invention includes the following steps:

In the step 300, a control unit determines that data need to be transmitted over multiple paths between the transmitting side and the receiving side; and

In the step 301, the control unit instructs the transmitting side to transmit the data over the multiple paths, so that the transmitting side transmits the same data to the receiving side over the multiple paths.

If the data are transmitted in the uplink, then the transmitting side is the terminal side, and the receiving side is the network side; and

If the data are transmitted in the downlink, then the transmitting side is the network side, and the receiving side is the terminal side.

The control unit determines that the data need to be transmitted over multiple paths between the transmitting side and the receiving side as follows:

If the transmitting side is the terminal side, then the control unit determines the data need to be transmitted over multiple paths, according to the performance of the transmitting side, and/or a service to be transmitted; and

If the receiving side is the terminal side, then the control unit determines the data need to be transmitted over multiple paths, according to the performance of the receiving side, and/or a service to be transmitted.

For example, the control unit can start transmission over the multiple paths because transmission through a primary connection system fails to accommodate the performance of the receiving side, or the reliability and a delay as required for the service.

Optionally after the control unit determines that the data need to be transmitted over the multiple paths, the method further includes:

The control unit instructs the receiving side to transmit the data over the multiple paths, so that the receiving side receives the same data respectively over the different paths.

For example, the control unit instructs the transmitting side and the receiving side to participate in transmission over the multiple paths, and notifies them of various configured parameters for transmission over the multiple paths (e.g., a feedback mode, the number of retransmissions, etc.), by interacting with the transmitting side and the receiving side via signaling.

Optionally after the control unit determines that the data need to be transmitted over the multiple paths between the transmitting side and the receiving side, and before the control unit instructs the transmitting side to transmit the data over the multiple paths, the method further includes:

The control unit selects such ones of the paths between the transmitting side and the receiving side that can accommodate a required delay, as paths for transmission between the transmitting side and the receiving side over the multiple paths, and determines the transmitting side and the receiving side corresponding to the transmission paths.

Optionally the control unit is located in the transmitting side or the receiving side, or is a separate unit entity.

The structures of the respective units as described above will be described below in details.

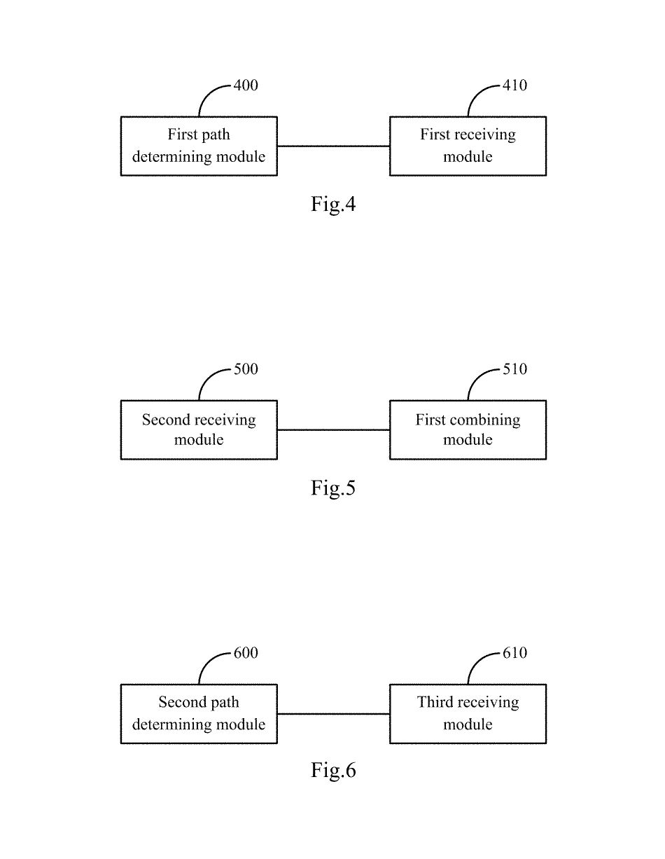

As illustrated in FIG. 4, a first receiving unit according to a fourth embodiment of the invention includes:

A first path determining module 400 is configured to determine paths to the transmitting side; and

A first receiving module 410 is configured to receive data from the transmitting side over the determined paths together with other first receiving units, where the same data are received over the respective paths.

Optionally each of the first receiving units 410 is located in a base station or a cell of a wireless communication system.

Optionally the first receiving module 410 is further configured:

To transmit the received data to a first data interface unit, so that the first data interface unit combines the received data from the plurality of first receiving units over the multiple paths.

Optionally the first receiving module 410 is further configured:

For a data packet in the data, to instruct the transmitting side to stop the data packet from being transmitted, when a part or all of the following conditions are satisfied:

At least one of the first receiving units receives correctly the data packet of the transmitting side, or the first data interface unit determines that the data packet is received correctly, after combining the data over the multiple paths;

A part or all of the first receiving units have received the same data packet from the transmitting side for such a number of times that reaches the largest number of transmissions; and

The data packet from the transmitting side is received at such a delay that reaches the longest transmission delay.

As illustrated in FIG. 5, a first data interface unit according to a fifth embodiment of the invention includes:

A second receiving module 500 is configured to receive data from a plurality of first receiving units, where the data of each first receiving unit are data received from the transmitting side over a different path, and the same data are transmitted over each path; and

A first combining module 510 is configured to combine the received data from the plurality of first receiving units over the multiple paths.

Optionally each of the first receiving units is located in a base station or a cell of a wireless communication system.

Optionally the first data interface unit and the first receiving unit are located in the same entity or different entities.

As illustrated in FIG. 6, a second receiving unit according to a sixth embodiment of the invention includes:

A second path determining module 600 is configured to determine paths to a second data interface unit; and

A third receiving module 610 is configured to receive first specific data from the second data interface unit over the determined paths, where the first specific data are obtained by the second data interface unit combining data received over multiple paths, over each of which the same data are transmitted.

Optionally the third receiving module 610 is further configured:

For a data packet in the data, to instruct the transmitting side to stop the data packet from being transmitted, when a part or all of the following conditions are satisfied:

The second data interface unit determines that the data packet is received correctly, after combining the data over the multiple paths;

The same data packet from the transmitting side over one of the paths or all the paths has been received for such a number of times that reaches the largest number of transmissions;

and

The data packet transmitted from the transmitting side is received at such a delay that reaches the longest transmission delay.

Optionally the second data interface unit and the second receiving unit are located in a terminal; or

The second data interface unit and the second receiving unit are located in different entities, and the second receiving unit is located in a terminal.

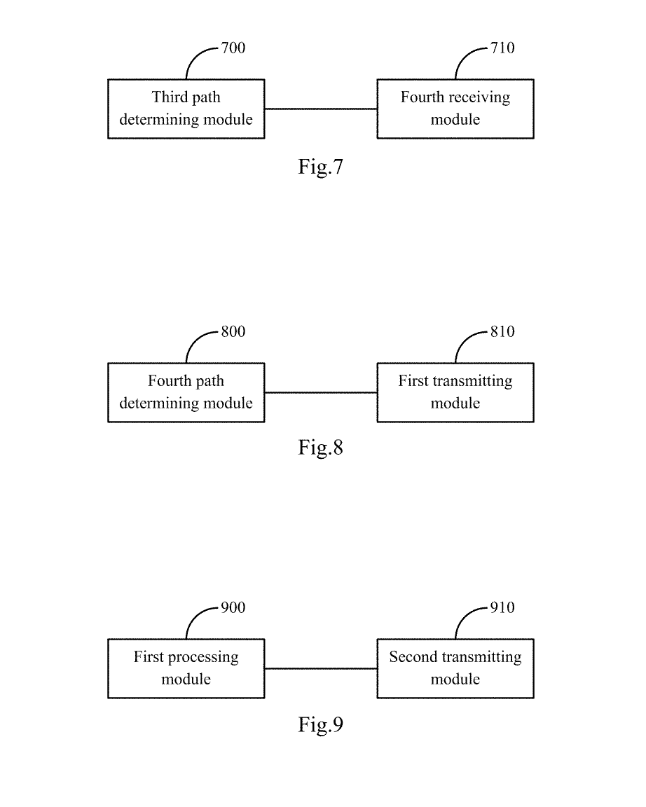

As illustrated in FIG. 7, a second data interface unit according to a seventh embodiment of the invention includes:

A third path determining module 700 is configured to determine multiple paths to the transmitting side; and

A fourth receiving module 710 is configured to receive data from the transmitting side over the determined multiple paths, to combine the received data over the multiple paths, and to transmit the combined data to a second receiving unit, where the same data are received over the respective paths.

Optionally the fourth receiving module 710 is further configured:

For a data packet in the data, to instruct the transmitting side to stop the data packet from being transmitted, when a part or all of the following conditions are satisfied:

The second data interface unit determines that the data packet is received correctly, after combining the data over the multiple paths;

The same data packet from the transmitting side over one of the paths or all the paths has been received for such a number of times that reaches the largest number of transmissions; and

The data packet from the transmitting side is received at such a delay that reaches the longest transmission delay.

Optionally the second data interface unit and the second receiving unit are located in a terminal; or

The second data interface unit and the second receiving unit are located in different entities, and the second receiving unit is located in a terminal.

As illustrated in FIG. 8, a first transmitting unit according to an eighth embodiment of the invention includes:

A fourth path determining module 800 is configured to determine paths to the receiving side; and

A first transmitting module 810 is configured to transmit data to the receiving side over the determined paths together with other first transmitting modules, where the same data are transmitted over the respective paths.

Optionally each of the first transmitting unit is located in a base station or a cell of a wireless communication system.

Optionally the first transmitting module 810 is further configured:

To receive second specific data from a first data processing unit, and to determine the second specific data as data to be transmitted, where the second specific data are obtained by the first data processing unit backing up the data to be transmitted, for the multiple paths.

As illustrated in FIG. 9, a first data processing unit according to a ninth embodiment of the invention includes:

A first processing module 900 is configured to back up data to be transmitted, for multiple paths; and

A second transmitting module 910 is configured to transmit the processed data respectively to respective first transmitting units, so that the respective first transmitting units transmit the same data to the receiving side respectively over the respective different paths.

Optionally each of the first transmitting units is located in a base station or a cell of a wireless communication system.

Optionally the first data processing unit and the first transmitting unit are located in the same entity or different entities.

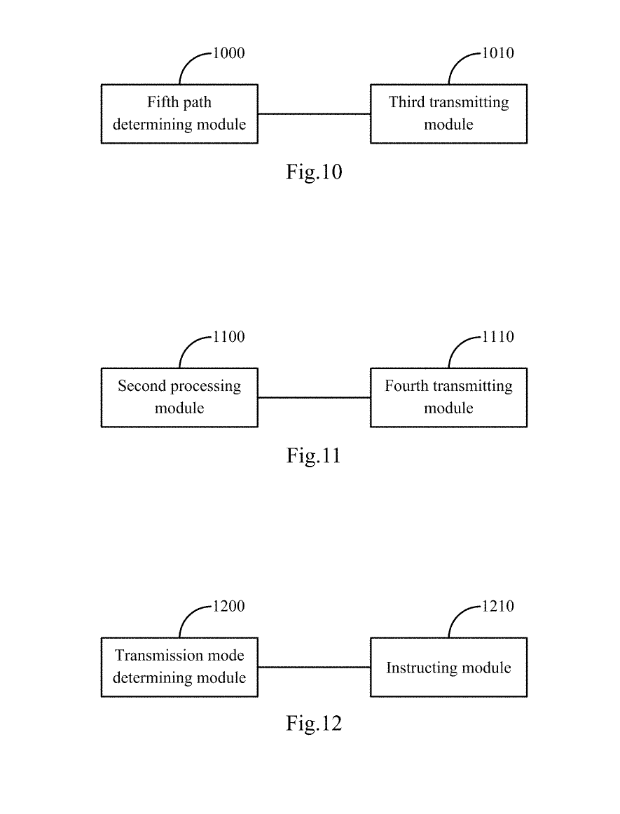

As illustrated in FIG. 10, a second transmitting unit according to a tenth embodiment of the invention includes:

A fifth path determining module 1000 is configured to determine paths to a second data processing unit; and

A third transmitting module 1010 is configured to transmit data to the second data processing unit over the determined paths, so that the second data processing unit backs up the received data for multiple paths, and transmits a plurality of duplicated data packets obtained as a result of backing up to the receiving side respectively over the multiple paths.

Optionally the second data processing unit and the second transmitting unit are located in a terminal; or

The second data processing unit and the second transmitting unit are located in different entities, and the second transmitting unit is located in a terminal.

As illustrated in FIG. 11, a second data processing unit according to an eleventh embodiment of the invention includes:

A second processing module 1100 is configured to back up received data from a second transmitting unit for multiple paths; and

A fourth transmitting module 1100 is configured to transmit a plurality of duplicated data packets obtained as a result of backing up to the receiving side respectively over the multiple paths.

Optionally the second data processing unit and the second transmitting unit are located in a terminal; or

The second data processing unit and the second transmitting unit are located in different entities, and the second transmitting unit is located in a terminal.

As illustrated in FIG. 12, a control unit according to a twelfth embodiment of the invention includes:

A transmission mode determining module 1200 is configured to determine that data need to be transmitted between the transmitting side and the receiving side over multiple paths; and

An instructing module 1210 is configured to instruct the transmitting side to transmit over the multiple paths, so that the transmitting side transmits the same data to the receiving side over the multiple paths.

Optionally the transmission mode determining module 1200 is configured:

If the transmitting side is the terminal side, to determine that the data need to be transmitted over the multiple paths, according to the performance of the transmitting side, and/or a service to be transmitted; and

If the receiving side is the terminal side, to determine that the data need to be transmitted over the multiple paths, according to the performance of the receiving side, and/or a service to be transmitted.

Optionally the instructing module 1210 is further configured:

To instruct the receiving side to receive over the multiple paths, so that the receiving side receives the same data respectively over the different paths.

Optionally the transmission mode determining module 1200 is further configured:

To select such ones of the paths between the transmitting side and the receiving side that can accommodate a required delay, as the paths for multipath transmission between the transmitting side and the receiving side, and to determine the transmitting side and the receiving side corresponding to the transmission paths.

Optionally the control unit is located in the transmitting side or the receiving side, or is a separate unit entity.

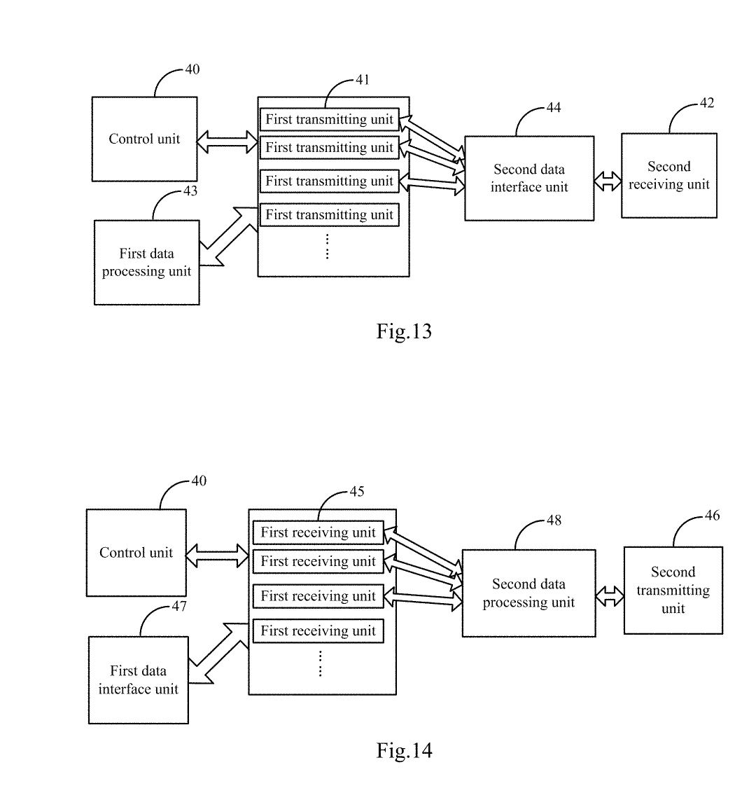

As illustrated in FIG. 13, a system for downlink transmission according to a thirteenth embodiment of the invention includes a control unit 40, a first transmitting unit 41, a second receiving unit 42, a first data processing unit 43, and a second data interface unit 44.

Reference can be made to the respective embodiments above for particular functions of the respective units above, so a repeated description thereof will be omitted here.

As illustrated in FIG. 14, a system for uplink transmission according to a fourteenth embodiment of the invention includes a control unit 40, a first receiving unit 45, a second transmitting unit 46, a first data interface unit 47, and a second data processing unit 48.

Reference can be made to the respective embodiments above for particular functions of the respective units above, so a repeated description thereof will be omitted here.

The solution according to the embodiments of the invention will be further described below in connection with several examples thereof.

In a first example, the control unit centrally controls a plurality of wireless communication systems.

As illustrated in FIG. 15 which is a schematic diagram of a control unit centrally controlling a plurality of wireless communication systems according to a fifteenth embodiment of the invention, the control unit can be located in some wireless communication system (e.g., a 5G wireless communication system, and particularly some network node (e.g., a gateway (GW)) or a base station in a core network of the 5G wireless communication system); or some node (e.g., a PDN GW (PGW)) or a base station in a core network of an existing wireless communication system), or can be a separate entity.

In downlink transmission, wireless communication systems 2 and 3 transmit, and a terminal receives; and

In uplink transmission, the terminal transmits, and the wireless communication systems 2 and 3 receive.

In the first step, the control unit determines the type of the terminal, or a service to be transmitted for the terminal, and the reliability and a delay as required for the terminal, and selects those wireless communication systems which can satisfy the required delay in one or more transmissions, e.g., the wireless communication systems 2 and 3 as illustrated in FIG. 15.

In the second step, the control unit notifies or negotiates with the selected wireless communication systems, and the wireless communication systems decide to participate in transmission over multiple paths.

In the third step, the control unit or the selected wireless communication systems notifies or notify the terminal of which wireless communication systems are to participate in transmission over the multiple paths, and the terminal prepares for transmission over the multiple paths, such as setup connection, synchronization, etc.

In the fourth step, the plurality of wireless communication systems transmit service data for the terminal.

In downlink transmission, when higher-layer service data of the network side (e.g., service data from an IP network) is arrived, then the selected wireless communication systems (e.g., the wireless communication system 2 and the wireless communication system 3) transmit service data packets respectively to the terminal. The wireless communication system 2 and the wireless communication system 3 can transmit separately from each other, or can interact with each other via related signaling and data.

In uplink transmission, when service data arrive, then the terminal transmits the same service data to all the selected wireless communication systems (e.g., the wireless communication system 2 and the wireless communication system 3).

In the fifth step, the receiving side receives and processes the data, including detecting the data for duplication.

In downlink transmission, the terminal receives data packets from the plurality of wireless communication systems, and detects the data packets for duplication, and sorts the data packets (optionally the terminal detects the data packets over the different transmission paths, and if there are a plurality of same data packets, then the terminal maintains only one of them while discarding the other duplicated data packets; and thereafter the terminal sorts the data packets by the identifiers of the data packets for convenient submission to a higher layer).

Optionally the terminal can make a necessary feedback to thereby reduce the number of duplicated transmissions so as to avoid resources from being wasted. For example, the terminal transmits correct reception feedbacks to both the wireless communication system 2 and the wireless communication system 3, or only one of the wireless communication systems, upon accurate reception of a data packet, and in the latter case, the wireless communication systems can interact with each other via signaling to stop transmission.

In uplink transmission, the wireless communication systems 2 and 3 receive uplink data packets separately from each other, and notify the terminal upon correct reception thereof or after the largest number of transmissions and/or the longest transmission delay is reached.

Preferably the data received by the wireless communication systems 2 and 3 can be combined (by one of the wireless communication systems, or the control unit), and the terminal can be notified after the data are received correctly.

In a second example, the control unit controls a plurality of cells in a wireless communication system.

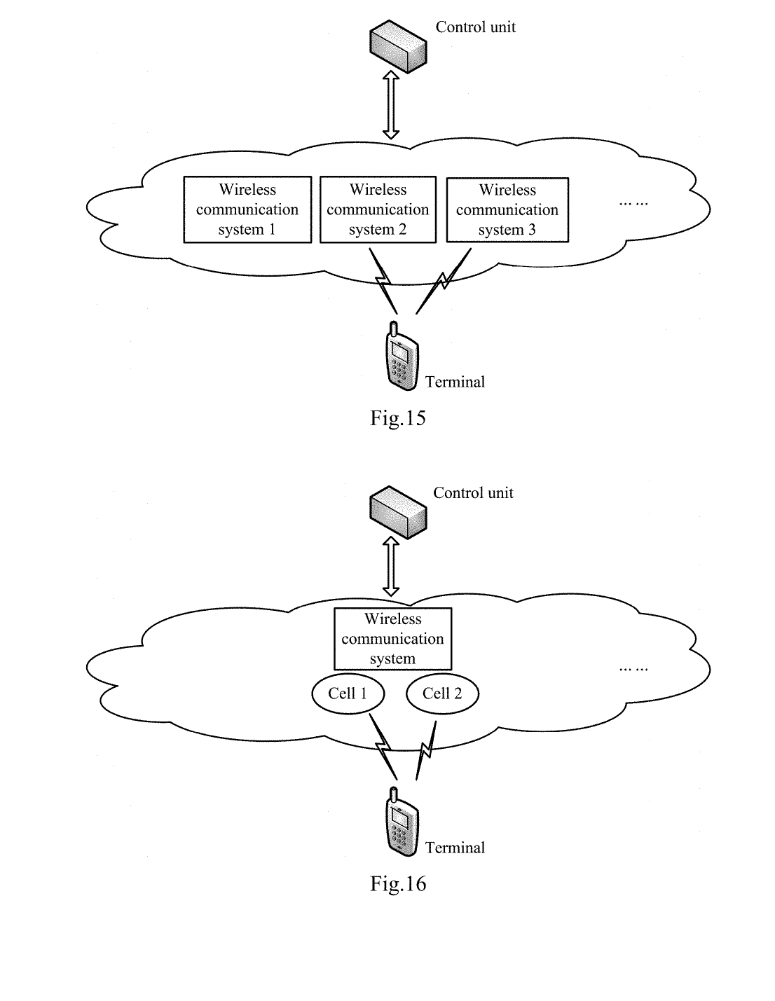

As illustrated in FIG. 16 which is a schematic diagram of a control unit centrally controlling a plurality of cells in a wireless communication system according to a sixteenth embodiment of the invention, the control unit can be a node in the wireless communication system, e.g., a base station or a core network node, or can be a separate entity.

In downlink transmission, cells 1 and 2 transmit, and a terminal receives;

In uplink transmission, the terminal transmits, and the cells 1 and 2 receive.

In the first step, the control unit determines the type of the terminal, or a service to be transmitted for the terminal, and the reliability and a delay as required for the terminal, and selects a plurality of cells to participate in transmission over multiple paths, e.g., the cell 1 and the cell 2 as illustrated in FIG. 16.

In the second step, the control unit interacts with the base station and the terminal via signaling to notify the base station and the terminal of the cells to participate in transmission over the multiple paths, and various parameters for transmission over the multiple paths (e.g., a feedback mode, the number of retransmissions, etc.)

In the third step, the plurality of cells transmit service data for the terminal.

In downlink transmission, when service data arrive, then the selected cells (e.g., the cell 1 and the cell 2) transmit service data packets to the terminal. The cell 1 and the cell 2 can be controlled by the same node (e.g., the base station), or different nodes (e.g., base stations).

In uplink transmission, when service data arrive, then the terminal transmits the same service data to all the selected cells.

In the fourth step, the receiving side receives and processes the data, including detecting the data for duplication.

In downlink transmission, the terminal receives data packets from the plurality of cells, and detects the data packets for duplication, and sorts the data packets (optionally the terminal detects the data packets over the different transmission paths, and there are a plurality of duplicated data packets, then the terminal will maintain only one of them while discarding the other duplicated data packets; and thereafter the terminal sorts the data packets by the identifiers of the data packets for convenient submission to a higher layer).

Optionally the terminal can make a necessary feedback to thereby reduce the number of duplicated transmissions so as to avoid resources from being wasted. For example, the terminal transmits correct reception feedbacks to both the cell 2 and the cell 3, or only one of the cells, upon accurate reception of a data packet.

In uplink transmission, the cells 1 and 2 receive uplink data packets separately from each other, and notify the terminal upon correct reception thereof or after the largest number of transmissions and/or the longest delay is reached.

Preferably the data received by the cells 1 and 2 can be combined, and the terminal can be notified after the data are received correctly.

In a third example, transmission over a plurality of path is started as a result of negotiation.

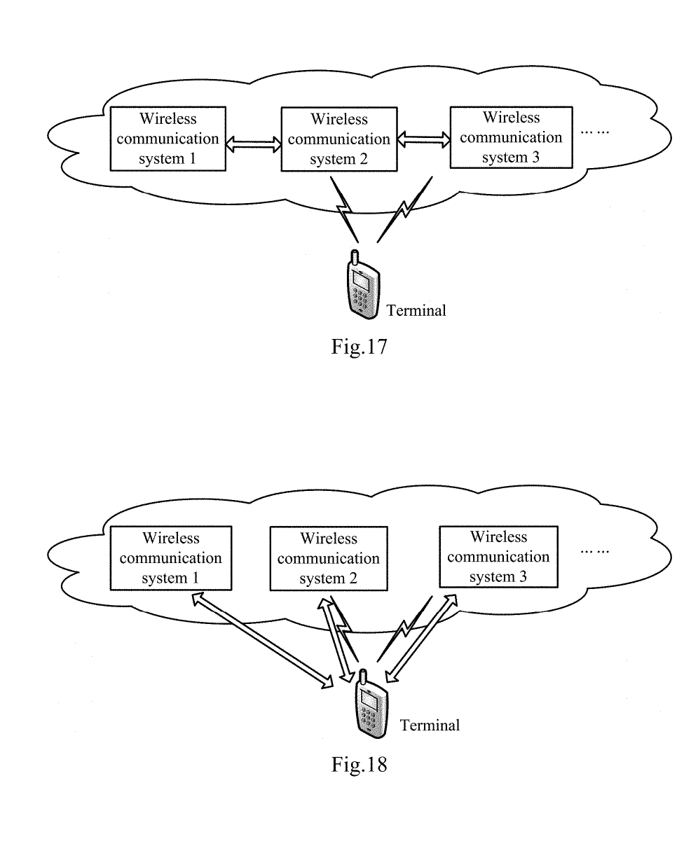

As illustrated in FIG. 17 which is a schematic diagram of starting transmission over a plurality of path as a result of negotiation according to a seventeenth embodiment of the invention, a control unit is one of wireless communication systems, which can be referred to as a primary connection system, and the control unit can be located on some core network entity (e.g., a GW) or a base station of the primary connection system.

In downlink transmission, wireless communication systems 2 and 3 transmit, and a terminal receives; and

In uplink transmission, the terminal transmits, and the wireless communication systems 2 and 3 receive.

In the first step, the wireless communication system 2 is the primary connection system of the terminal, which is referred to as a Primary Radio Access Technology (PRAT) system, e.g., the wireless communication system 2 as illustrated in FIG. 17. The primary connection system determines the reliability and a delay as required for the terminal or a service, and determines whether to start transmission over multiple paths (for example, if transmission through the primary connection system fails to satisfy the reliability and the delay as required for the terminal or the service, then transmission over the multiple paths can be started), and if it is determined to start transmission over multiple paths, then the primary connection system selects those wireless communication systems with transmission paths satisfying the required delay to participate in transmission over the multiple paths (e.g., the wireless communication system 2 and the wireless communication system 3 as illustrated in FIG. 17).

In the second step, the primary connection system interacts with the selected wireless communication systems via signaling (generally request and acknowledgement or request and rejection signaling) to determine the wireless communication systems to participate in transmission over the multiple paths, e.g., the wireless communication systems 2 and 3 to participate in transmission over the multiple paths as a result of negotiation in FIG. 17.

In the third step, the primary connection system (the wireless communication system 2) instructs the terminal to start transmission over the multiple paths, and notifies the terminal of necessary information about transmission over the multiple paths, e.g., the wireless communication system to participate in transmission over the multiple paths; and the terminal prepares for transmission over the multiple paths, such as setup connection, synchronization, etc.

In the fourth step, the plurality of wireless communication systems transmit service data for the terminal.

In downlink transmission, when higher-layer service data of the network side (e.g., service data from an IP network) is arrived, then the selected wireless communication systems (e.g., the wireless communication system 2 and the wireless communication system 3) can transmit service data packets respectively to the terminal. The wireless communication system 2 and the wireless communication system 3 can transmit separately from each other, or can interact with each other via related signaling and data.

In uplink transmission, when service data arrive, then the terminal can transmit the same service data to all the selected wireless communication systems (e.g., the wireless communication system 2 and the wireless communication system 3).

In the fifth step, the receiving side receives and processes the data, including detecting the data for duplication.

In downlink transmission, the terminal receives data packets from the plurality of wireless communication systems, and detects the data packets for duplication, and sorts the data packets (optionally the terminal detects the data packets over the different transmission paths, and if there are a plurality of same data packets, then the terminal maintains only one of them while discarding the other duplicated data packets; and thereafter the terminal sorts the data packets by the identifiers of the data packets for convenient submission to a higher layer).

Optionally the terminal can make a necessary feedback to thereby reduce the number of duplicated transmissions so as to avoid resources from being wasted. For example, the terminal transmits correct reception feedbacks to both the wireless communication system 2 and the wireless communication system 3, or only one of the wireless communication systems, upon accurate reception of a data packet, and in the latter case, the wireless communication systems can interact with each other via signaling to stop transmission.

In uplink transmission, the wireless communication systems 2 and 3 receive uplink data packets separately from each other, and notify the terminal upon correct reception thereof or after the largest number of transmissions and/or the longest transmission delay is reached. Preferably the data received by the wireless communication systems 2 and 3 can be combined (by one of the wireless communication systems, or an intermediary unit), and the terminal can be notified after the data are received correctly.

In a fourth example, a terminal controls transmission over multiple paths.

As illustrated in FIG. 18 which is a schematic diagram of a terminal controlling transmission over multiple paths to an eighteenth embodiment of the invention, a control unit is the terminal.

In downlink transmission, wireless communication systems 2 and 3 transmit, and the terminal receives; and

In uplink transmission, the terminal transmits, and the wireless communication systems 2 and 3 receive.

In the first step, the terminal decides to transmit over multiple paths while guaranteeing a delay and the reliability, according to a delay and the reliability as required for the terminal or some service, and selects wireless communication systems likely to participate in transmission over the multiple paths.

In the second step, the terminal is connected with the plurality of wireless communication systems, and requests for transmission over the multiple paths. The wireless communication systems respond. For example, the wireless communication system 2 and the wireless communication system 3 as illustrated in FIG. 18 can participate in transmission over the multiple paths.

In the third step, the plurality of wireless communication systems transmit service data for the terminal.

In downlink transmission, when higher-layer service data of the network side (e.g., service data from an IP network) arrive, then the selected wireless communication systems (e.g., the wireless communication system 2 and the wireless communication system 3) can transmit service data packets respectively to the terminal. The wireless communication system 2 and the wireless communication system 3 can transmit separately from each other, or can interact with each other via related signaling and data.

In uplink transmission, when service data arrive, then the terminal can transmit the same service data to all the selected wireless communication systems (e.g., the wireless communication system 2 and the wireless communication system 3).

In the fourth step, the receiving side receives and processes the data, including detecting the data for duplication.

In downlink transmission, the terminal receives data packets from the plurality of wireless communication systems, and detects the data packets for duplication, and sorts the data packets (optionally the terminal detects the data packets over the different transmission paths, and if there are a plurality of duplicated data packets, then the terminal maintains only one of them while discarding the other duplicated data packets; and thereafter the terminal sorts the data packets by the identifiers of the data packets for convenient submission to a higher layer).

Optionally the terminal can make a necessary feedback to thereby reduce the number of duplicated transmissions so as to avoid resources from being wasted. For example, the terminal transmits correct reception feedbacks to both the wireless communication system 2 and the wireless communication system 3, or only one of the wireless communication systems, upon accurate reception of a data packet, and in the latter case, the wireless communication systems can interact with each other via signaling to stop transmission.

In uplink transmission, the wireless communication systems 2 and 3 receive uplink data packets separately from each other, and notify the terminal upon correct reception thereof or after the largest number of transmissions and/or the longest transmission delay is reached.

Preferably the data received by the wireless communication systems 2 and 3 can be combined (by one of the wireless communication systems, or an intermediary unit), and the terminal can be notified after the data are received correctly.

In a fifth example, terminals guarantee an end-to-end delay and reliability through blindly redundant transmission.

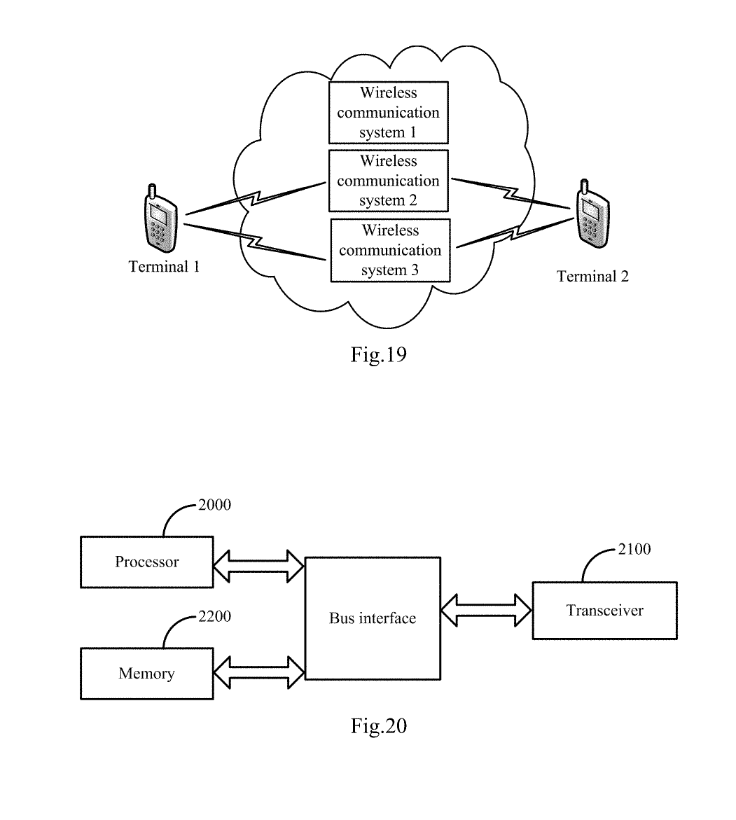

As illustrated in FIG. 19 which is a schematic diagram of a terminal transmitting in a blindly redundant mode according to a nineteenth embodiment of the invention, a control unit is the terminal.

In downlink transmission, wireless communication systems 2 and 3 transmit, and terminals receive; and

In uplink transmission, the terminals transmit, and the wireless communication systems 2 and 3 receive.

In the first step, the terminal 1 decides to transmit over multiple paths while guaranteeing a delay and the reliability, according to a delay and the reliability as required for the terminal or some service. The terminal can make a general decision, and select wireless communication systems likely to participate in transmission over the multiple paths.

In the second step, the terminal 1 transmits the same service data to the selected plurality of wireless communication systems. Transmission over the multiple paths is transparent to the wireless communication systems participating in transmission over the multiple paths, that is, the participating wireless communication systems do not know that they participate in transmission over the multiple paths.

In the third step, the terminal 2 receives the transmitted service data from the plurality of wireless communication systems, detects the data, combines the data, detects the data for duplication, and sorts the data.

Preferably the terminals can alternatively negotiate in advance about and determine their connected wireless communication systems, and select those wireless communication systems from them to participate in transmission over multiple paths.

The third, fourth, and fifth embodiments of the invention can also be applicable to transmission over multiple paths in a plurality cells in a wireless communication system.

As illustrated in FIG. 20, a base station according to a twentieth embodiment of the invention includes a processor 2000, a transceiver 2100, and a memory 2200, where:

The transceiver 2100 is configured to be controlled by the processor 2000 to transmit and receive data; and

The memory 2200 is configured to store data for use by the processor 2000 in operation.

If the base station is a receiver, then the processor 2000 can be configured to read programs in the memory, and to perform the processes of:

Determining paths to the transmitting side; and

Receiving data from the transmitting side through the transceiver 2100 over the determined paths together with other base stations, where the same data are received over each of the paths.

If the base station is a transmitter, then the processor 2000 can be configured to read the data in the memory, and to perform the processes of:

Determining paths to the receiving side; and

Transmitting data from the receiving side through the transceiver 2100 over the determined paths together with other base stations, where the same data are transmitted over each of the paths.

In FIG. 20, the bus architecture can include any number of interconnected buses and bridges to link together various circuits including one or more processors represented by the processor 2000, and one or more memories represented by the memory 2200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The transceiver 2100 can include a number of elements, e.g., a transmitter and a receiver, configured to provide units for communication with various other devices over a transmission medium. The processor 2000 is responsible for managing the bus architecture and typical processes, and the memory 2200 can store data to be used by the processor 2000 in operation.

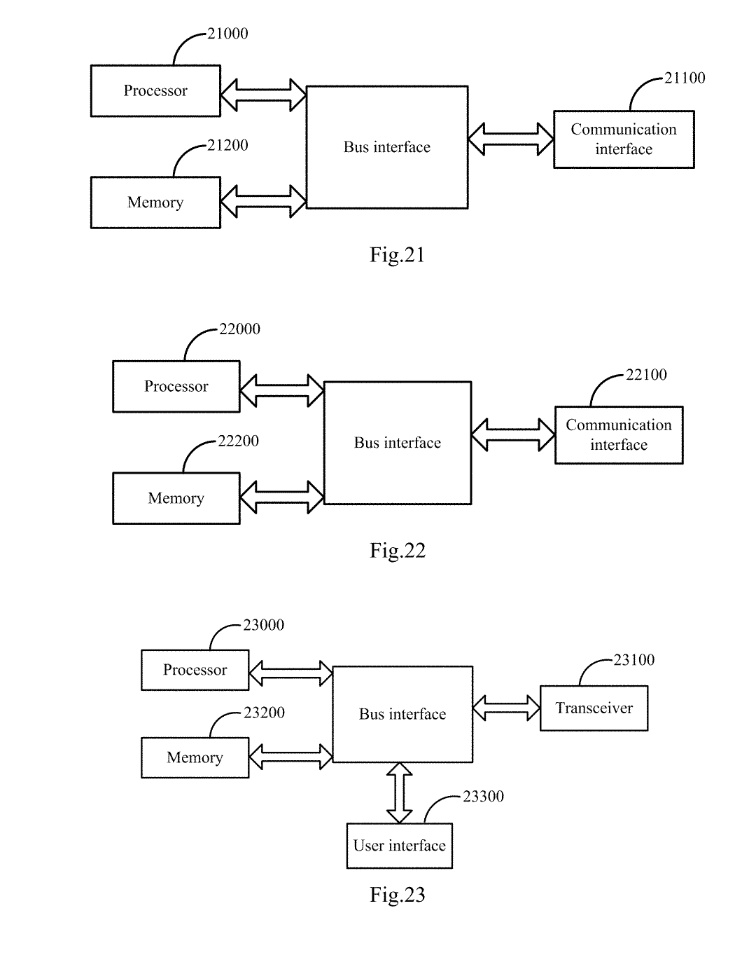

As illustrated in FIG. 21, a first data interface unit for transmitting data according to a twenty-first embodiment of the invention includes a processor 21000, a communication interface 21100, and a memory 21200, where:

The processor 21000 is configured to read programs in the memory 21200, and to perform the processes of:

Receiving data from a plurality of base stations via the communication interface 21100, where the data of each base station are data from the transmitting side over different one of paths, over each of which the same data are transmitted; and

Combining the received data from the plurality of base stations over the multiple paths;

The communication interface 21100 is configured to be controlled by the processor 21000 to transmit data to other entities at the network side, and to be controlled by the processor 21000 to receive data transmitted by the other entities at the network side; and

The memory 21200 is configured to store data for use by the processor 21000 in operation.

In FIG. 21, the bus architecture can include any number of interconnected buses and bridges to link together various circuits including one or more processors represented by the processor 21200, and one or more memories represented by the memory 21200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The processor 21000 is responsible for managing the bus architecture and typical processes, and the memory 21200 can store data to be used by the processor 21000 in operation.

As illustrated in FIG. 22, a first data processing unit for transmitting data according to a twenty-second embodiment of the invention includes a processor 22000, a communication interface 22100, and a memory 22200, where:

The processor 22000 is configured to read data from the memory 22200, and to perform the processes of:

Backing up data to be transmitted, for multiple paths; and

Transmitting the processed data respectively to respective first transmitting units via the communication interface 22100, so that the respective first transmitting units transmit the same data to the receiving side respectively over the respective different paths.

In FIG. 22, the bus architecture can include any number of interconnected buses and bridges to link together various circuits including one or more processors represented by the processor 22000, and one or more memories represented by the memory 22200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The processor 22000 is responsible for managing the bus architecture and typical processes, and the memory 22200 can store data to be used by the processor 22000 in operation.

The communication interface 22100 is configured to be controlled by the processor 22000 to transmit data to other entities at the network side, and to be controlled by the processor 22000 to receive data transmitted by the other entities at the network side; and

The memory 22200 is configured to store data for use by the processor 22000 in operation.

As illustrated in FIG. 23, a terminal according to a twenty-third embodiment of the invention includes a processor 23000, a memory 23200, and a transceiver 23100, where:

The memory 23200 is configured to store data for use by the processor 23000 in operation; and

The transceiver 23100 is configured to be controlled by the processor 23000 to transmit and receive data.

If the terminal is a receiver, then the processor 23000 can be configured to read programs in the memory 23200, and to perform the processes of:

Receiving data from the transmitting side over multiple paths, over each of which the same data are transmitted; and

Combining the received data over the multiple paths.

If the terminal is a transmitter, then the processor 23000 can be configured to read programs in the memory 23200, and to perform the processes of: Deciding to transmit with the receiving side over multiple paths; and

Transmitting data to the receiving side through the transceiver 23100 over the multiple paths, over each of which the same data are transmitted.

In FIG. 23, the bus architecture can include any number of interconnected buses and bridges to link together various circuits including one or more processors represented by the processor 23000, and one or more memories represented by the memory 23200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The transceiver 23100 can include a number of elements, e.g., a transmitter and a receiver, configured to provide units for communication with various other devices over a transmission medium. For different user equipments, the user interface 23300 can also be an interface via which external or internal devices are connected as appropriate, where the connected devices include but will not be limited to a keypad, a display, a speaker, a microphone, a joystick, etc.

The processor 23000 is responsible for managing the bus architecture and typical processes, and the memory 23200 can store data to be used by the processor 23000 in operation.

As illustrated in FIG. 24, a second data interface unit for transmitting data according to a twenty-fourth embodiment of the invention includes a processor 24000, a memory 24200, and a communication interface 24100, where:

The processor 24000 is configured to read programs in the memory 24200, and to perform the processes of:

Determining multiple paths to the transmitting side; and

Receiving data from the transmitting side over the determined multiple paths, combining the received data over the multiple paths, and transmitting the combined data to a second receiving unit via the communication interface, where the same data are received over each of the paths;

The memory 24200 is configured to store data for use by the processor 24000 in operation; and

The communication interface 24100 is configured to be controlled by the processor 24000 to receive data of a terminal, and to be controlled by the processor 24000 to transmit data to the terminal.

In FIG. 24, the bus architecture can include any number of interconnected buses and bridges to link together various circuits including one or more processors represented by the processor 24000, and one or more memories represented by the memory 24200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The processor 24000 is responsible for managing the bus architecture and typical processes, and the memory 24200 can store data to be used by the processor 24000 in operation.

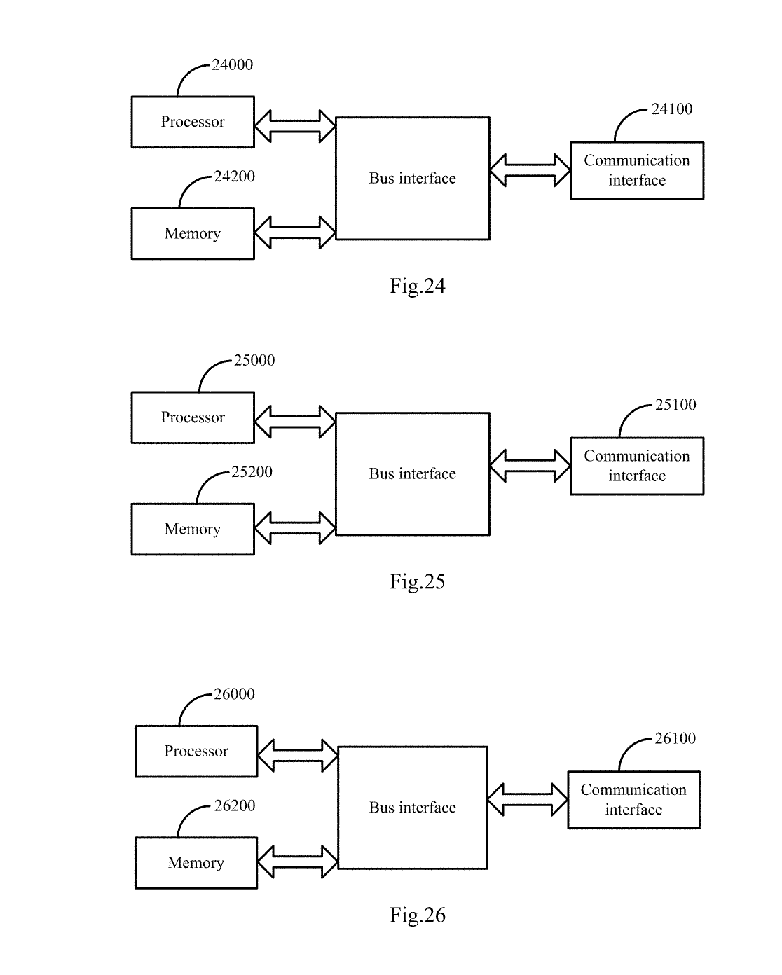

As illustrated in FIG. 25, a second data processing unit for transmitting data according to a twenty-fifth embodiment of the invention includes a processor 25000, a memory 25200, and a communication interface 25100, where:

The processor 25000 is configured to read program in the memory 25200, and to perform the processes of:

Backing up data, received via the communication interface 25100 from a terminal, for multiple paths; and

Transmitting a plurality of duplicated data packets obtained as a result of backing up to the receiving side respectively over the multiple paths.

In FIG. 25, the bus architecture can include any number of interconnected buses and bridges to link together various circuits including one or more processors represented by the processor 25000, and one or more memories represented by the memory 25200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The processor 25000 is responsible for managing the bus architecture and typical processes, and the memory 25200 can store data to be used by the processor 25000 in operation.

As illustrated in FIG. 26, a control unit for transmitting data according to a twenty-sixth embodiment of the invention includes:

A processor 26000 is configured to read programs in a memory 26200, and to perform the processes of:

Determining that data need to be transmitted between the transmitting side and the receiving side over multiple paths; and

Instructing the transmitting side via a communication interface 26100 to transmit over the multiple paths, so that the transmitting side transmits the same data to the receiving side over the multiple paths;

The memory 26200 is configured to store data for use by the processor 26000 in operation; and

The communication interface 26100 is configured to be controlled by the processor 26000 to exchange data with the transmitting side and the receiving side.

In FIG. 26, the bus architecture can include any number of interconnected buses and bridges to link together various circuits including one or more processors represented by the processor 26000, and one or more memories represented by the memory 26200. The bus architecture can further link together various other circuits, e.g., peripheral devices, a voltage stabilizer, a power management circuit, etc., and all of these circuits are well known in the art, so a further description thereof will be omitted in this context. The bus interface provides an interface. The processor 26000 is responsible for managing the bus architecture and typical processes, and the memory 26200 can store data to be used by the processor 26000 in operation.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for data transmission, the method comprising:
receiving, by a receiving side, data from a transmitting side over multiple paths, over each of which the same data are received; and
combining, by the receiving side, the received data over the multiple paths.

2. The method according to claim 1, wherein the receiving side is a network side, and the receiving side comprises a plurality of first receiving units participating in transmission over the multiple paths; and
receiving, by the receiving side, the data from the transmitting side over the multiple paths comprises:
receiving, by each of the first receiving units, the data from the transmitting side over respective one of the paths.

3. The method according to claim 2, wherein each of the first receiving units is located in a base station or a cell of a wireless communication system.

4. The method according to claim 2, wherein combining, by the receiving side, the received data over the multiple paths comprises:
transmitting, by each of the first receiving units, the received data to the same first receiving unit participating in transmission over the multiple paths, or the first receiving unit in a primary connection; and
combining, by the first receiving unit receiving the data transmitted by the other first receiving units, the received data from the transmitting side with the received data from the other first receiving units over the multiple paths;
or
wherein combining, by the receiving side, the received data over the multiple paths comprises:
transmitting, by each of the first receiving units, the receive data to a first data interface unit in the receiving side; and
combining, by the first data interface unit, the received data from the plurality of first receiving units over the multiple paths.

5. (canceled)

6. The method according to claim 4, wherein the method further comprises:
for a data packet in the data, receiving, by the one of the first receiving units which is connected with the transmitting side by the primary connection, or the first data interface unit, the data packet, and instructing the transmitting side to stop the data packet from being transmitted, when a part or all of the following conditions are satisfied:
at least one of the first receiving units receives correctly the data packet of the transmitting side, or the first data interface unit determines that the data packet is received correctly, after combining the data over the multiple paths;
a part or all of the first receiving units have received the same data packet from the transmitting side for such a number of times that reaches a largest number of transmissions; and
the data packet transmitted from the transmitting side is received at such a delay that reaches a longest transmission delay.

7. The method according to claim 1, wherein the receiving side is the terminal side, and the receiving side comprises one second data interface unit and one second receiving unit;
receiving, by the receiving side, the data from the transmitting side over the multiple paths comprises:
receiving, by the second data interface unit, the data from the transmitting side over the multiple paths;
combining, by the receiving side, the received data over the multiple paths comprises:
combining, by the second data interface unit, the received data over the multiple paths; and
after the receiving side combines the received data over the multiple paths, the method further comprises:
transmitting, by the second data interface unit, the combined data to the second receiving unit.

8. The method according to claim 7, wherein the method further comprises:
for a data packet in the data, instructing, by the second data interface unit or the second receiving unit, the transmitting side to stop the data packet from being transmitted, when a part or all of the following conditions are satisfied:
the second data interface unit determines that the data packet is received correctly, after combining the data over the multiple paths;
the same data packet from the transmitting side over one of the paths or all the paths has been received for such a number of times that reaches a largest number of transmissions; and
the data packet transmitted from the transmitting side is received at such a delay that reaches a longest transmission delay.

9. The method according to claim 7, wherein:
the second data interface unit and the second receiving unit are located in a terminal; or
the second data interface unit and the second receiving unit are located in different entities, and the second receiving unit is located in a terminal.

10. A method for transmitting data, the method comprising:
determining, by a transmitting side, that data need to be transmitted to a receiving side over multiple paths; and
transmitting, by the transmitting side, the data to the receiving side over the multiple paths, over each of which the same data are transmitted.

11. The method according to claim 10, wherein the transmitting side is a network side, and the transmitting side comprises a plurality of first transmitting units participating in transmission over the multiple paths; and
transmitting, by the transmitting side, the data to the receiving side over the multiple paths comprises:
transmitting, by each of the first transmitting units, the same data to the receiving side over respective one of the paths.

12. The method according to claim 11, wherein each of the first transmitting units is located in a base station or a cell of a wireless communication system.

13. The method according to claim 11, wherein before the transmitting side transmits the data to the receiving side over the multiple paths, the method further comprises:
backing up, by a first data processing unit in the transmitting side, the data to be transmitted, and transmitting a plurality of duplicated data packets obtained as a result of backing up respectively to the respective first transmitting units.

14. The method according to claim 10, wherein the transmitting side is a terminal side, and the transmitting side comprises one second data processing unit and one second transmitting unit;
before the transmitting side transmits the data to the receiving side over the multiple paths, the method further comprises:
transmitting, by the second transmitting unit, the data to be transmitted, to the second data processing unit; and
transmitting, by the transmitting side, the data to the receiving side over the multiple paths comprises:
backing up, by the second data processing unit, the received data for the multiple paths, and transmitting a plurality of duplicated data packets obtained as a result of backing up to the receiving side respectively over the multiple paths.

15. The method according to claim 14, wherein:
the second data processing unit and the second transmitting unit are located in a terminal; or
the second data processing unit and the second transmitting unit are located in different entities, and the second transmitting unit is located in the terminal.

16. The method according to claim 10, wherein after the transmitting side transmits the data to the receiving side over the multiple paths, the method further comprises:
stopping, by the transmitting side, the data from being transmitted over all the paths, upon reception of a feedback from the receiving side that the data are received correctly or stopped from being transmitted.

17. A method for transmitting data, the method comprising:
determining, by a control unit, that data need to be transmitted over multiple paths between a transmitting side and a receiving side; and
instructing, by the control unit, the transmitting side to transmit the data over the multiple paths, so that the transmitting side transmits the same data to the receiving side over the multiple paths.

18. The method according to claim 17, wherein determining, by the control unit, that the data need to be transmitted over the multiple paths between the transmitting side and the receiving side comprises:
if the transmitting side is a terminal side, then determining, by the control unit, the data need to be transmitted over multiple paths, according to the performance of the transmitting side, and/or a service to be transmitted; or
if the receiving side is the terminal side, then determining, by the control unit, the data need to be transmitted over multiple paths, according to the performance of the receiving side, and/or a service to be transmitted.

19. The method according to claim 17, wherein after the control unit determines that the data need to be transmitted over the multiple paths between the transmitting side and the receiving side, the method further comprises:
instructing, by the control unit, the receiving side to receive the data over the multiple paths, so that the receiving side receives the same data respectively over the different paths.

20. The method according to claim 17, wherein after the control unit determines that the data need to be transmitted over the multiple paths between the transmitting side and the receiving side, and before the control unit instructs the transmitting side to transmit the data over the multiple paths, the method further comprises:
selecting, by the control unit, such ones of paths between the transmitting side and the receiving side that can accommodate a required delay, as paths for transmission between the transmitting side and the receiving side over the multiple paths, and determining the transmitting side and the receiving side corresponding to the transmission paths.

21. The method according to claim 17, wherein the control unit is located in the transmitting side or the receiving side, or is a separate unit entity.

22-49. (canceled)
